(19) United States
(12) Patent Application Publication
(10) Pub. No.: US 2008/0281064 A1
(43) Pub. Date: Nov. 13, 2008

(54) Novel Glycopolymers, Uses Thereof, and Monomers Useful for Preparation Thereof

(75) Inventors: Stephanie Chiron, Paris (FR); Marie-Pierre Labeau, Burlington, NJ (US); Etienne Fleury, Irigny (FR); David Viet, Toulon (FR); Sylvain Cottaz, Herbeys (FR); Hugues Driguez, Grenoble (FR); Sami Halila, Voreppe (FR)

Correspondence Address: BUCHANAN, INGERSOLL & ROONEY PC, POST OFFICE BOX 1404, ALEXANDRIA, VA, 22313-1404, US

(73) Assignees: RHODIA CHIMIE, Boulogne Billancourt Cedex (FR); CENTRE NATIONAL DE LA RECHERCHE SCIENTIFIQUE, Paris Cedex I6 (FR)

(21) Appl. No.: 11/632,623

(22) PCT Filed: Jul. 12, 2005
(86) PCT No.: PCT/FR05/01799

§ 371 Date: Apr. 28, 2008

(30) Foreign Application Priority Data
Jul. 13, 2004 (FR) 0407818

(51) Int. Cl. C08L 5/00

(52) U.S. Cl. 526/238.2

(57) ABSTRACT

Novel glycopolymers, uses thereof, and monomers useful for preparation thereof are provided. Methods for preparing novel monomers and glycopolymers are also provided. An exemplary polymer can include glycoside containing units and cationic or potentially cationic units.

A subject matter of the present invention is novel glycopolymers, their uses and novel monomers of use in their preparation. The invention also relates to processes for preparation of the novel monomers and glycopolymers.

Glycopolymers are polymers comprising units comprising a glycoside unit. They can be obtained by polymerization of monomers comprising a glycoside, by copolymerization in the presence of other monomers or by grafting to a polymer functionalized for this purpose.

Numerous compounds comprising a glycoside group, generally a monoglycoside group, and a polymerizable group, for example a double bond, have been described. The polymerization of such compounds has also been described.

For example, the document WO 90/10023 discloses glycopolymers comprising units derived from acrylamide and units deriving from monomers of formula R²—NH—CO—CX═CH₂ where X is H or a methyl group and R² is a glycoside. These monomers are obtained from compounds of formula R²—NH₂ in which the R² group is bonded to the —NH₂ group via a reducing anomeric carbon.

The present invention provides other glycopolymers and other monomers comprising a glycoside. These novel glycopolymers and monomers can be of use in adjusting the properties of the glycopolymers and can thus make it possible, when they are used, to provide novel products. It is thus possible to adjust the properties of polymers used, for example, in cosmetic compositions.

Furthermore, glycopolymers are attracting increasing interest in the industrial and/or consumables fields as they are products derived from natural products, benefiting from a positive image in terms of environmental protection and/or of harmfulness and/or more simply of marketing. There exists a need for such products.

Thus, the invention provides a polymer comprising units comprising a glycoside, characterized in that it comprises:
cationic or potentially cationic units A_{C} preferably deriving from a cationic or potentially cationic mono-α-ethylenically unsaturated monomer, and
units deriving from a monomer of following formula (I):

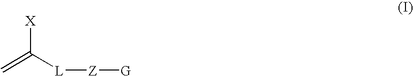

in which
   X is a hydrogen atom or a methyl group
   L is a divalent linking group
   Z is an oxygen or sulfur atom or a group comprising a nitrogen atom and
   G is a glycoside.

The invention also relates to uses of the polymer in compositions. The invention also relates to compositions comprising the polymer.

The invention also relates to a monomer particularly suitable for the preparation of the polymer according to the invention. Thus, the invention also provides a monomer of following formula (I′)

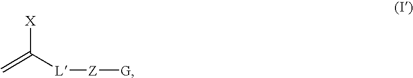

in which:
X is a hydrogen atom or a methyl group
Z is an oxygen atom or a group comprising a nitrogen atom and
G is a glycoside,
   characterized in that:
the -L′-Z-G group exhibits the following formula (II′):

—COY-L¹-S-L²-Z-G (II′)
in which
   Y is a divalent linking group or a linking atom,
   L¹ is a divalent linking group, preferably a divalent hydrocarbon group, preferably a divalent C₁-C₆ alkyl group,
   L² is a divalent linking group, preferably a divalent hydrocarbon group, preferably a divalent C₁-C₆ alkyl group, and
   G is bonded to Z via an anomeric carbon of the glycoside.

The monomer according to the invention can be used for the preparation of the polymers according to the invention. It can also be used for the preparation of other polymers, for example homopolymers of said monomer, or for the preparation of copolymers not comprising cationic or potentially cationic units but comprising other units. It may involve, for example, copolymers comprising units deriving from the monomer of formula (I′) and, as other units, neutral, anionic and/or potentially anionic and hydrophobic and/or hydrophilic units. Such units are described subsequently.

### DEFINITIONS

The term “polymer” is understood to mean any macromolecular compound comprising repeat units. Polymers include in particular homopolymers, copolymers, oligomers, cooligomers, telomers and cotelomers.

The term “copolymer” is understood to mean any polymer comprising at least two different repeat units. Copolymers include in particular random copolymers, controlled structure copolymers, cooligomers (copolymers of relatively low molecular weight) and cotelomers.

The term “controlled structure (co)polymer” is understood to mean any (co)polymer where the sequence of the units is controlled (for example, diblock or triblock copolymers but also concentration gradient polymers) and/or where the polydispersity is controlled (for example, random (co)polymers having a polydispersity index of 1 to 1.5), in contrast to the (co)polymers obtained by standard polymerization processes, which do not make possible such a control of the arrangement of the individual units or of the polydispersity indices, if low. It may concern a copolymer comprising at least two parts A and B with distinct compositions of repeat units. The parts of a controlled structure copolymer can in particular be blocks, linear backbones, side chains, grafts, “hairs” or branches of microgels or of stars, cores of stars or of microgels, or alternatively parts of polymer chains exhibiting different concentrations of different units. Thus, the controlled structure, which a copolymer can exhibit, can be chosen from the following structures:
block copolymer, comprising at least two blocks, the part A corresponding to one block, the part B corresponding to another block. The part A is generally composed of several different units, if appropriate exhibiting a composition gradient. The part A can also exhibit a random copolymer structure. Thus, the part A can exhibit a homopolymer structure (if it comprises Az units), a random copolymer structure or a composition gradient copolymer structure. It can, for example, be a (block A)-(block B)-(block A) or (block B)-(block A)-(block B) or (block A)-(block B) block copolymer.
comb or graft copolymer, comprising a backbone and side chains, with the part A corresponding to the backbone and the part B corresponding to side chains, or with the part B corresponding to the backbone and the part A corresponding to side chains.
star or microgel copolymer, comprising a polymer or nonpolymer core and peripheral polymer chains, one part corresponding to the core, the other part corresponding to the peripheral chains. The part A can correspond to the core and the part B can correspond to the peripheral chains. Conversely, the part B can correspond to the core and the part A can correspond to the peripheral chains.

The term “monomers” is understood to mean compounds which can be used for the preparation of polymers, homopolymers or copolymers (it is also possible to speak of comonomers). The repeat units of the polymers derive from these monomers.

In the present patent application, the term “unit deriving from a monomer” denotes a unit which can be obtained directly from said monomer by polymerization. Thus, for example, a unit deriving from an acrylic or methacrylic acid ester does not cover a unit of formula —CH₂—CH(COOH)—, —CH₂—C(CH₃)(COOH)— or —CH₂—CH(OH)— respectively, obtained, for example, by polymerizing an acrylic acid ester, a methacrylic acid ester or vinyl acetate respectively and by then hydrolyzing. A unit deriving from acrylic or methacrylic acid covers, for example, a unit obtained by polymerizing a monomer (for example, an acrylic or methacrylic acid ester) and by then reacting (for example by hydrolysis) the polymer obtained so as to obtain units of formula —CH₂—CH(COOH)— or —CH₂—C(CH₃)(COOH)—. A unit deriving from a vinyl alcohol covers, for example, a unit obtained by polymerizing a monomer (for example, a vinyl ester), and by then reacting (for example by hydrolysis) the polymer obtained so as to obtain units of formula —CH₂—CH(OH)—.

In the present patent application, unless otherwise mentioned, the average molar masses are absolute weight-average molar masses which can be measured by steric exclusion chromatography in an appropriate solvent (for example, deionized Millipore water, if appropriate), coupled to a refractometer, to a conductivity meter and to a multi-angle light scattering detector, with extrapolation to angle zero (GPC-MALS).

In the present patent application, “Ac” represents an acetyl group of formula —COCH₃.

In the present patent application, the term glycoside refers to any group comprising one or more glycoside units, and to the derivatives of these groups. In the case where the glycoside comprises several glycoside units, the term “polyglycosides” is also used. The term “polyglycoside” is understood to mean a glycoside comprising at least two glycoside units.

Glycoside units, glycosides, polyglycosides, their derivatives, their structures and formulae are known to a person skilled in the art. It is specified, for the glycoside units, that it can be a matter in particular of aldoses, of ketoses or of derivatives in rings comprising 5 atoms (pentoses) or 6 atoms (hexoses). In addition, it is known to a person skilled in the art that glycosides, polyglycosides and their derivatives exhibit a reducing “anomeric carbon” at one end, the right-hand end according to writing conventions. It is also known that glycoside units, glycosides, polyglycosides and their derivatives exhibit optionally protected hydroxyl (—OH), carboxylic acid or amine groups.

Glycosides include in particular:
O-, S-, N- or C-alkyl or -aryl glycosides optionally comprising at least one —COOH group, monoglycosides and polyglycosides.

Mention is made, as examples of monosaccharide glycosides, of the following glycosides;

glucose (for example D-glucose), fructose, sorbose, mannose, galactose, talose, allose, gulose, idose, glucosamine, mannoamine, galactosamine, glucuronic acid, rhamnose, arabinose, galacturonic acid, fucose, xylose, lyxose, ribose, generally the isomers of sucrose, such as palatinose.

Mention is made, as examples of di- or oligosaccharide glycosides, of the following glycosides:
disaccharides: maltose, gentiobiose, lactose, cellobiose, isomaltose, melibiose, laminaribiose, chitobiose, xylobiose, mannobiose or sophorose,
oligosaccharides:
maltodextrins, in particular maltotriose, isomaltotriose, maltotetraose, maltopentaose or maltoheptaose,
generally branched oligosaccharides, such as xyloglucan and its derivatives,
mannotriose or mannotriose,
chitotriose, chitotetraose or chitopentaose,
cellotetraoses or cellodextrins
generally di- or oligosaccharides exhibiting α- or β-1, -2, -3, -4, -5 or -6 bonds.

Mention is also made, as examples of glycosides, of:
starch derivatives, in particular maltose or maltodextrins,
cellulose derivatives,
pectins and their derivatives,
chitin, chitosan and their derivatives,
glucoaminoglucans and their derivatives,
xyloglucan derivatives (in particular the derivatives obtained by hydrolysis, for example by enzymatic hydrolysis),
galactomannans and their derivatives, for example guar polymers and their derivatives obtained by hydrolysis of natural guar and optionally chemical modification (derivatization). Natural guar is extracted from the albumin of certain plant seeds, for example Cyamopsis tetragonalobus. The guar macromolecule is composed of a linear main chain formed from β-D-mannose monomeric sugars bonded to one another via (1-4) bonds and α-D-galactose side units bonded to the β-D-mannoses via (1-6) bonds.

Polyglycosides, comprising several glycoside units, can be described as sequences of glycosides (mono- and/or polyglycosides). In the present patent application, a sequence of glycosides is described by the formula G^{a}-G^{b}-, in which G^{a} is a glycoside or a polyglycoside and G^{b} is a glycoside or a polyglycoside. In the case where G^{a} or G^{b} is a polyglycoside, the latter can also be described by a formula G^{a′}-G^{b′}-, in which G^{a′} is a glycoside or a polyglycoside and G^{b′} is a glycoside or a polyglycoside, and so on. Glycosides or polyglycosides which can constitute G^{a}, G^{b}, G^{a′}, G^{b′}, and the like, groups have been mentioned above.

### Monomers of Formula (I) or (I′)

The polymer comprises units deriving from a monomer of following formula (I):

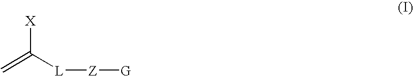

in which
   X is a hydrogen atom or a methyl group
   L is a divalent linking group
   Z is an oxygen or sulfur atom or a group comprising a nitrogen atom, and
   G is a glycoside.

G can be bonded to -Z- via an anomeric carbon atom or via another carbon atom.

G can in particular be bonded via:
the anomeric carbon via O, S, N, CH₂—O, CH₂—S or CH₂—N (glycosides are obtained).
the oxidized anomeric carbon, opening the lactone formed with an amine, forming an amide bond.

G can also be grafted by reductive amination.

If G comprises an acid or amine functional group on other positions, it is possible to graft via this functional group.

Preferably:
Z is an oxygen atom or an —NH— or —N[COCH₃]— group, and
G is bonded to -Z- via an anomeric carbon of the glycoside.

According to one embodiment, the -L-Z-G group is a group of formula —O—CH₂CH₂—O-G. Monomers exhibiting such a group are sold, for example, by Nippon Seika under the name Sucrograph.

According to another embodiment, the -L-Z-G group can be a group of formula —CO—NH-G or —CO-aryl-NH-G.

According to a specific embodiment of the invention, the monomer of formula (I) is a monomer of formula (I′) as described below.

### Monomer of Formula (I′)

A monomer particularly suited to the implementation of the invention exhibits the following formula (I′)

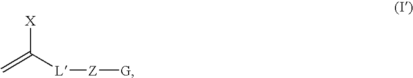

in which:
X is a hydrogen atom or a methyl group
Z is an oxygen atom or a group comprising a nitrogen atom and
G is a glycoside,
   characterized in that:
the -L′-Z-G group exhibits the following formula (II′):

—COY-L¹-S-L²-Z-G (II′)
in which
   Y is a divalent linking group or a linking atom,
   L¹ is a divalent linking group, preferably a divalent hydrocarbon group, preferably a divalent C₁-C₆ alkyl group,
   L² is a divalent linking group, preferably a divalent hydrocarbon group, preferably a divalent C₁-C₆ alkyl group, and
   G is bonded to Z via an anomeric carbon of the glycoside.

Thus, the compound of formula (I′) exhibits the following formula (I″):

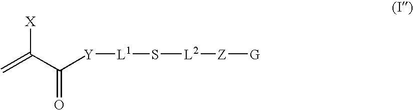

Preferably:
Y is —O— or —NH—, and
L¹ and L², which are identical or different, are C₁-C₄ alkyl groups.

According to a particular form, the monomer of formula (I) or (I′) or (I″) exhibits the following formula (III′):

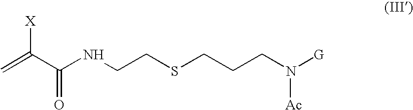

In this formula:
the -Z- group of the formula (I) or (I′) or (I″) is the —N(COCH₃)— group,
the -L- or -L′- group of the formula (I) or (I′) is the —CONH—(CH₂)₂—S—(CH₂)₃— group,
the —COY— group of the formula (II′) is the —CONH— group,
the L¹ group of the formula (II′) is the —(CH₂)₂— group, and
the L² group of the formula (II′) is the —(CH₂)₃— group.

In particular, the monomer of the formula (I), (I′), (I″) or (III″) can exhibit one of the following formulae:

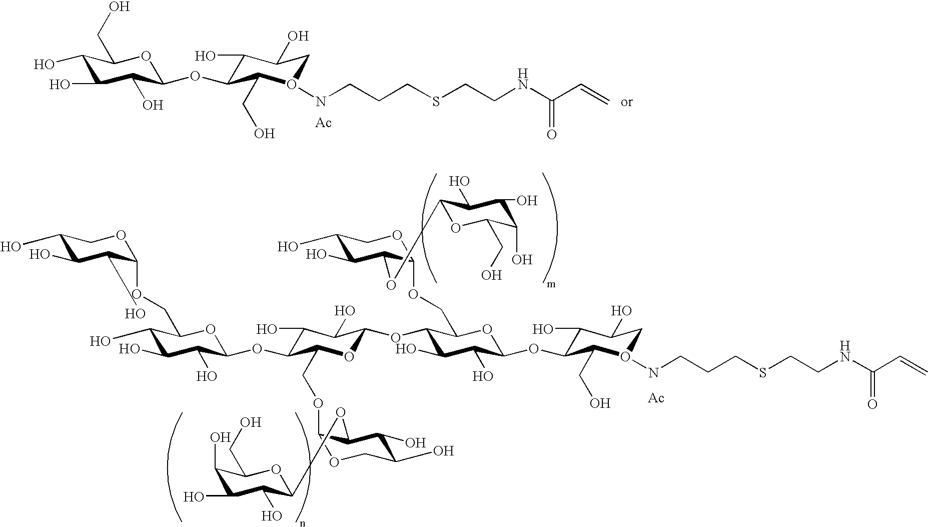

in which:
m and n, which are identical or different, are numbers from 0 to 10, preferably 0 or 1.

### Process for the Preparation of the Monomer of Formula (I′)

The monomer of formula (I′) can be prepared by a process comprising the following stages:
stage a): Functionalization of an anomeric carbon of a glycoside of formula HO-G, where the —OH group under consideration is carried by the anomeric carbon, by a functionalization reactant comprising an amine group, preferably a primary amine group, or an alcohol group and a group comprising an unsaturation (for example, alkene or alkyne type). The functionalization reactant is preferably allylamine. A product of formula CH₂═CH₂-L′²-Z-G where Z has the above definition is thus obtained, in which product the CH₂═CH₂-L′² group will constitute the -L²- group after stage b).
One embodiment of this stage can be represented by the following reaction scheme:

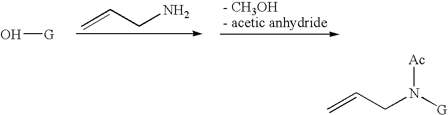

The reaction can be carried out in the absence of solvent, at ambient temperature, but other reaction methods are not ruled out.

Thus, stage a) can comprise the following stages:

a1) reaction of the anomeric carbon of a glycoside of formula G-OH, comprising free —OH groups, with excess allylamine,
a2) removal of the excess allylamine,
a3) reaction with acetic anhydride, so as to protect the nitrogen atom and optionally primary —OH groups of the glycoside.

Stage a3) of reaction with acetic anhydride can be carried out under conditions such that at least a portion of the —OH groups of the glycoside are acetylated, in addition to the nitrogen atom. It is possible to promote this acetylation of —OH groups or to retain it or to eliminate it during a subsequent stage, for example, by a slightly basic treatment which hydrolyzes the O-acetate groups.
Stage b): Reaction with a compound comprising an HS— group and an —OH or —NH₂ group, for example cysteamine, so as to obtain a product of formula Y′-L¹-S-L²-Z-G, in which Y′ is an —OH or —NH₂ group.

The addition of the compound can be carried out by radical reaction, either in the presence of a radical initiator or by photochemical reaction. In both cases, the reaction preferably takes place in a minimum amount of solvent, for example water, if need be while heating. According to an advantageous form, the reaction is carried out in an aqueous medium. According to a particular advantageous form, the reaction is carried out in an aqueous medium using a water-soluble radical initiator. This embodiment can make it possible in particular to employ smaller amounts of solvent, to increase the reaction kinetics and to improve the final yield obtained. Initiators which can be used are known to a person skilled in the art. Mention is made, by way of examples, of V50 (α,α′-azodiisobutyramidine dihydrochloride), VA-041 (2,2′-azobis[2-(5-methyl-2-imidazolin-2-yl)propane]dihydrochloride) or VA-060 (2,2′-azobis{2-[1-(2-hydroxyethyl)-2-imidazolin-2-yl]propane}dihydrochloride). One embodiment of this stage can be represented by the following reaction scheme:

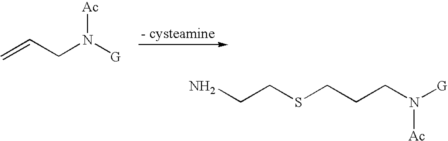

Stage c): Reaction with a compound of formula CH₂═CXCOY″ in which Y″ is an —OH, —NH₂ or —Cl group, for example (meth)acrylic acid, acrylamide or acryloyl chloride, so as to obtain the product of formula (I′). It is specified that stage c) is preferably a reaction of chemical and nonenzymatic type. The reaction can take place at ambient temperature and more advantageously under cold conditions in a solvent medium, for example in water or a water/alcohol mixture. The solvent mixture is preferably adjusted in order for the opposing compounds to be satisfactorily soluble. The alcohol can, for example, be methanol, isopropyl alcohol or tert-butyl alcohol. In order to scavenge the hydrochloric acid released, a base: sodium carbonate, sodium acetate, tertiary amine, and the like, can be introduced into the medium. The reaction is generally fast. One embodiment of this stage can be represented by the following reaction scheme:

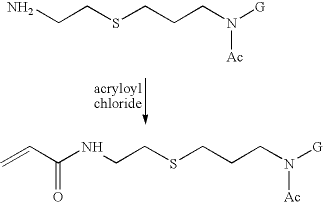

For all the embodiments, the glycoside G is preferably a polyglycoside. Glycosides which can constitute G groups of monomers of formula (I), (I′), (I″), or (III′) have been described above in the “Definitions” section.

### Cationic or Potentially Cationic Monomers or Units

The polymer according to the invention comprises cationic or potentially cationic units A_{C} which can derive from cationic or potentially cationic monomers.

The term “cationic or potentially cationic units A_{C}” is understood to mean units which comprise a cationic or potentially cationic group. Cationic units or groups are units or groups which exhibit at least one positive charge (generally in combination with one or more anions, such as the chloride ion, the bromide ion, a sulfate group or a methyl sulfate group), whatever the pH of the medium in which the copolymer is present. Potentially cationic units or groups are units or groups which may be neutral or which may exhibit at least one positive charge, depending on the pH of the medium in which the copolymer is present. In this case, reference will be made to potentially cationic units A_{C} in the neutral form or in the cationic form. By extension, it is possible to speak of cationic or potentially cationic monomers.

Mention may be made, as examples of potentially cationic hydrophilic monomers (from which units A_{C} can derive), or:
ω-(N,N-dialkylamino)alkylamides of α,β-monoethylenically unsaturated carboxylic acids, such as 2-(N,N-dimethylamino)ethylacrylamide or -methacrylamide, 3-(N,N-dimethylamino)propylacrylamide or -methacrylamide, 4-(N,N-dimethylamino)butylacrylamide or -methacrylamide or methacrylamidoethylethyleneurea (Sipomer WAM II, sold by Rhodia),
α,β-monoethylenically unsaturated amino esters, such as 2-(dimethylamino)ethyl acrylate (ADAM), 2-(dimethylamino)ethyl methacrylate (DMAM), 3-(dimethylamino)propyl methacrylate, 2-(tertbutylamino)ethyl methacrylate, 2-(dipentylamino)ethyl methacrylate, 2-(diethylamino)ethyl methacrylate or methacryloyloxyethylethyleneurea,
vinylpyridines, vinylpyrrolidone or vinylcaprolactam,
vinylamine,
vinylimidazolines,
precursor monomers of amine functional groups, such as N-vinylformamide, N-vinylacetamide, and the like, which produce primary amine functional groups by simple acidic or basic hydrolysis.

Mention may be made, as examples of cationic hydrophilic monomers, from which units A_{C} can be derived, of:
ammonioacryloyl or -acryloyloxy monomers, such as trimethylammoniopropyl methacrylate chloride, trimethylammonioethylacrylamide or -methacrylamide chloride or bromide, trimethylammoniobutylacrylamide or -methacrylamide methyl sulfate, trimethylammoniopropylmethacrylamide methyl sulfate (MES), (3-methacrylamidopropyl)trimethylammonium chloride (MAPTAC), (3-acrylamidopropyl)trimethylammonium chloride (APTAC), (methacryloyloxyethyl)trimethylammonium chloride or methyl sulfate, (acryloyloxyethyl)trimethylammonium chloride or (acryloyloxyethyl)benzyldimethylammonium ethyl chloride (ADAMQUAT BZ);
1-ethyl-2-vinylpyridinium or 1-ethyl-4-vinylpyridinium bromide, chloride or methyl sulfate;
N,N-dialkyldiallylamine monomers, such as N,N-dimethyldiallylammonium chloride (DADMAC);
polyquatenary monomers, such as chloride of dimethylaminopropylmethacrylamide, N-(3-chloro-2-hydroxypropyl)trimethylammonium (DIQUAT), and the like.

### Other Monomers or Units

The polymer can also comprise other units, for example neutral hydrophilic or hydrophobic units A_{N} and/or anionic or potentially anionic units A_{A}.

The term “anionic or potentially anionic units A_{A}” is understood to mean units which comprise an anionic or potentially anionic group. Anionic units or groups are units or groups which exhibit at least one negative charge (generally in combination with one or more cations, such as cations of alkali metal or alkaline earth metal compounds, for example sodium, or cationic groups, such as ammonium), whatever the pH of the medium in which the copolymer is present. Potentially anionic units or groups are units or groups which may be neutral or which may exhibit at least one negative charge, depending on the pH of the medium in which the copolymer is present. In this case, reference will be made to potentially anionic units A_{A} in the neutral form or in the anionic form. By extension, it is possible to speak of anionic or potentially anionic monomers.

The term “neutral units A_{N}” is understood to mean units which do not exhibit a charge, whatever the pH of the medium in which the copolymer is present.

Mention may be made, as examples of anionic or potentially anionic monomers, from which units A_{A} can be derived, of:
monomers having at least one carboxyl functional group, such as α,β-ethylenically unsaturated carboxylic acids or the corresponding anhydrides, such as acrylic acid, acrylic anhydride, methacrylic acid, methacrylic anhydride, maleic acid, maleic anhydride, fumaric acid, itaconic acid, N-methacryloylalanine, N-acryloylglycine and their water-soluble salts,
precursor monomers of carboxylate functional groups, such as tert-butyl acrylate, which generate, after polymerization, carboxyl functional groups by hydrolysis,
monomers having at least one sulfate or sulfonate functional group, such as 2-sulfooxyethyl methacrylate, vinylbenzenesulfonic acid, allylsulfonic acid, 2-acrylamido-2-methylpropanesulfonic acid, sulfoethyl acrylate or methacrylate, sulfopropyl acrylate or methacrylate, and their water-soluble salts,
monomers having at least one phosphonate or phosphate functional group, such as vinylphosphonic acid, ethylenically unsaturated phosphate esters, such as the phosphates derived from hydroxyethyl methacrylate (Empicryl 6835 from Rhodia) and those derived from polyoxyalkylene methacrylates, and their water-soluble salts.

Mention may be made, as examples of neutral nonionic hydrophobic monomers, from which units A_{N} can be derived, of:
vinylaromatic monomers, such as styrene, α-methylstyrene, vinyltoluene, and the like,
vinyl or vinylidene halides, such as vinyl chloride or vinylidene chloride,
C₁-C₁₂ alkyl esters of α,β-monoethylenically unsaturated acids, such as methyl acrylate, methyl methacrylate, ethyl acrylate, ethyl methacrylate, butyl acrylate, butyl methacrylate, 2-ethylhexyl acrylate, and the like,
vinyl or allyl esters of saturated carboxylic acids, such as vinyl acetate, allyl acetate, vinyl propionate, allyl propionate, vinyl versatate, allyl versatate, vinyl stearate, allyl stearate, and the like,
α,β-monoethylenically unsaturated nitriles comprising from 3 to 12 carbon atoms, such as acrylonitrile, methacrylonitrile, and the like,
α-olefins, such as ethylene, and the like,
conjugated dienes, such as butadiene, isoprene or chloroprene,
monomers capable of generating polydimethylsiloxane (PDMS) chains.

Thus, the part B can be a silicone, for example a polydimethylsiloxane chain or a copolymer comprising dimethylsiloxy units.

Mention may be made, as examples of neutral nonionic hydrophilic monomers, from which units A_{N} can be derived, of:
hydroxyalkyl esters of α,β-ethylenically unsaturated acids, such as hydroxyethyl acrylate, hydroxyethyl methacrylate, hydroxypropyl acrylate, hydroxypropyl methacrylate, glycerol monomethacrylate, and the like,
α,β-ethylenically unsaturated amides, such as acrylamide, N,N-dimethylmethacrylamide, N-methylolacrylamide, and the like,
α,β-ethylenically unsaturated monomers carrying a water-soluble polyoxyalkylene segment of the polyethylene oxide type, such as polyethylene oxide α-methacrylates (Bisomer S20W, S10W, and the like, from Laporte) or α,ω-dimethacrylates, Sipomer BEM from Rhodia (ω-behenyl polyoxyethylene methacrylate), Sipomer SEM-25 from Rhodia (ω-tristyrylphenyl polyoxyethylene methacrylate), and the like,
α,β-ethylenically unsaturated precursor monomers of hydrophilic units or segments, such as vinyl acetate, which, once polymerized, can be hydrolyzed to generate vinyl alcohol units or polyvinyl alcohol segments.

### Polymer

The polymer according to the invention can be a random copolymer, a block copolymer, a concentration gradient copolymer, a star copolymer, a cooligomer or a cotelomer. It is preferably a random copolymer.

According to an advantageous embodiment, the polymer is water-soluble or water-dispersible. This means that said polymer does not form, in water, over at least in a certain pH and concentration range, a two-phase composition under the conditions of use.

The polymer according to the invention can be presented in particular in the form of a powder, in the form of a dispersion in a liquid or in the form of a solution in a solvent (water or other). The form depends generally on the requirements related to the use of the polymer. It can also be related to the process for the preparation of the polymer.

The polymer can comprise from 0.1% to 99.9% by number (molar) of units deriving from the monomer of formula (I) or (I′), with respect to the total number of units in the polymer. It preferably comprises from 0.1% to 15% by number (molar).

The polymer can comprise from 0.1% to 99.9% by number (molar) of cationic or potentially cationic units, with respect to the total number of units in the polymer. It preferably comprises from 0.1% to 15% by number (molar).

The absolute weight-average molar mass can preferably be between 1000 g/mol and 5 00 000 g/mol. It is preferably between 50 000 g/mol and 1 000 000 g/mol.

### Process for the Preparation of Polymers According to the Invention

The polymers according to the invention can be obtained by any known method, whether by controlled or uncontrolled radical polymerization, by polymerization by ring opening (in particular anionic or cationic, with appropriate monomers), by anionic or cationic polymerization or by chemical modification of a polymer.

Radical polymerization is preferably carried out in an environment devoid of oxygen, for example in the presence of an inert gas (helium, argon, nitrogen, and the like). The reaction is carried out in an inert solvent, preferably methanol or ethanol, and more preferably in water.

The polymerization is initiated by addition of a polymerization initiator. The initiators used are the free radical generators commonly used in the art. Examples comprise organic peresters; organic compounds of azo type, for example azobisamidinopropane hydrochloride, azobisisobutyronitrile, azobis(2,4-dimethylvaleronitrile), and the like; inorganic and organic peroxides, for example ammonium peroxide, sodium peroxide, potassium peroxide, hydrogen peroxide, benzoyl peroxide and butyl peroxide, and the like; redox initiator systems, for example those comprising oxidizing agents, such as persulfates (in particular ammonium or alkali metal persulfates and the like), chlorates and bromates (including inorganic or organic chlorates and/or bromates), and reducing agents, such as sulfites and bisulfites (including inorganic and/or organic sulfites or bisulfites), oxalic acid and ascorbic acid, and also mixtures of two or more of these compounds.

The preferred initiators are water-soluble initiators. Preference is given in particular to sodium persulfate and azobisamidinopropane hydrochloride.

In an alternative form, the polymerization can be initiated by irradiation using ultraviolet light. The amount of initiator used is generally an amount sufficient to carry out the initiation of the polymerization. Preferably, the initiators are present in an amount ranging from 0.001 to approximately 10% by weight, with respect to the total weight of the monomers, and are preferably in an amount of less than 2% by weight, with respect to the total weight of the monomers, a preferred amount lying in the range from 0.05 to 1% by weight, with respect to the total weight of the monomers. The initiator is added to the polymerization mixture either continuously or portionwise.

When it is desired to obtain copolymers of high molecular weight, it is desirable to add initiator during the polymerization reaction. The addition can be gradual or portionwise. The polymerization is carried out under reaction conditions which are effective in polymerizing the monomers (c) and the monomers (a) in an atmosphere devoid of oxygen. Preferably, the reaction is carried out at a temperature ranging from approximately 300 to approximately 1000 and preferably between 600 and 90° C. The atmosphere devoid of oxygen is maintained throughout the duration of the reaction, for example by flushing with nitrogen throughout the reaction.

Use may be made in particular of “living” or “controlled” radical polymerization methods. These methods are particularly useful for the preparation of controlled structure copolymers.

Reference may in particular be made, as examples of “living” or “controlled” polymerization processes, to:
the processes of applications WO 98/58974, WO 00/75207 and WO 01/42312, which employ a radical polymerization controlled by control agents of xanthate type,
the process for radical polymerization controlled by control agents of dithioester type of application WO 98/01478,
the process disclosed in application WO 02/08307, in particular in order to obtain copolymers comprising polyorganosiloxane blocks,
the process for radical polymerization controlled by control agents of dithiocarbamate type of application WO 99/31144,
the process for radical polymerization controlled by control agents of dithiocarbazate type of application WO 02/26836,
the process for radical polymerization controlled by control agents of dithiophosphoro ester type of application WO 02/10223,
   (the block copolymers obtained as above by controlled radical polymerization can optionally be subjected to a reaction for the purification of their sulfur-comprising chain end, for example by processes of hydrolysis, oxidation, reduction, pyrolysis or substitution type)
the process of application WO 99/03894, which employs a polymerization in the presence of nitroxide precursors,
the process of application WO 96/30421, which uses atom transfer radical polymerization (ATRP),
the process for radical polymerization controlled by control agents of iniferter type according to the teaching of Otu et al., Makromol. Chem. Rapid. Commun., 3, 127 (1982),
the process for radical polymerization controlled by degenerative transfer of iodine according to the teaching of Tatemoto et al., Jap. 50, 127, 991 (1975), Daikin Kogyo Co. Ltd, Japan, and Matyjaszewski et al., Macromolecules, 28, 2093 (1995),
the process for radical polymerization controlled by tetraphenylethane derivatives disclosed by D. Braun et al., in Macromol. Symp. 111, 63 (1996),
the process for radical polymerization controlled by organocobalt complexes described by Wayland et al. in J. Am. Chem. Soc., 116, 7973 (1994), or
the process for radical polymerization controlled by diphenylethylene (WO 00/39169 or WO 00/37507).

When grafted or comb controlled architecture copolymers are involved, the latter can be obtained by “direct grafting” and “copolymerization” methods.

Direct grafting consists in polymerizing the chosen monomer(s) by the radical route in the presence of the polymer selected to form the backbone of the final product. If the monomer/backbone pair and the operating conditions are carefully chosen, then there may be a transfer reaction between the growing macroradical and the backbone. This reaction generates a radical on the backbone and it is starting from this radical that the graft grows. The primary radical resulting from the initiator can also contribute to the transfer reactions.

As it relates to the copolymerization, it employs, in a first step, the grafting, at the end of the future pendant segment, of a functional group which can be polymerized by the radical route. This grafting can be carried out by conventional methods of organic chemistry. Then, in a second step, the macromonomer thus obtained is polymerized with the monomer chosen to form the backbone and a “comb” polymer is obtained. The grafting can advantageously be carried out in the presence of a polymerization control agent, such as mentioned in the above references.

The processes for the preparation of star-shaped polymers can essentially be classified into two groups. The first corresponds to the formation of the arms of the polymers starting from a multifunctional compound constituting the center (core-first technique) (Kennedy, J. P. et al., Macromolecules, 29, 8631 (1996), Deffieux, A. et al., ibid, 25, 6744, (1992), and Gnanou, Y. et al., ibid, 31, 6748 (1998)) and the second corresponds to a method where the polymer molecules which will constitute the arms are first synthesized and subsequently bonded together to a core to form a star-shaped polymer (arm-first technique).

Reference may be made, as an example of the synthesis of this type of polymer, to patent WO 00/02939. Mention may also be made of polymerization processes starting from a core comprising several transfer groups and of micelle crosslinking processes.

### Uses

The polymer according to the invention can be used in particular as emulsifying or coemulsifying agent for preparing or stabilizing emulsions. It can, for example, be used in emulsions, one phase of which is a silicone oil. It can also be used to render compatible several compounds within a formulation. It can also be used as agent for helping with the deposition of another compound or as initiator of the deposition of another compound. It can be of use in carrying a compound, for example a silicone, to a surface.

The polymer can in particular be used in cosmetic compositions, in detergent compositions for the care of the home, in compositions for caring for the laundry, or as molecular recognition agent, or as transmembrane passage agent, or as additive for paper pulp, coating composition for paper, paint, for example paint for wood. Mention may be made, as cosmetic compositions, of shampoos, conditioners, shower gels or creams for caring for the skin. These compositions can additionally comprise at least one anionic and/or amphoteric surfactant and optionally agents such as silicone oils, nonsilicone oils or polysaccharides which are optionally modified. In these compositions, the polymer can contribute conditioning effects, effects of helping with the conditioning, sensory or “cosmetic” effects, effects of feel, of softness, of suppleness, of helping in disentangling, of gloss, of ability to be styled on dry or wet hair.

Other details or advantages of the invention will become apparent in the light of the examples below, which do not have a limiting nature.

### EXAMPLES

### Example 1

### Synthesis of an N-acetyl-N—[(N-2-thioethyl)-2-propenamide]propyl]-β-D-glucopyranosyl-(1→4)-β-D-glucopyranosylamine monomer (product 4)

### Stage 1: Synthesis of N-acetyl-N-allyl-β-D-glucopyranosyl-(1→4)-β-D-glucopyranosylamine (product 2)

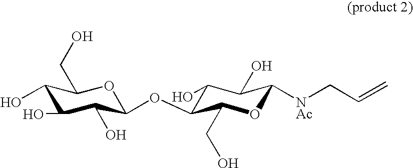

Cellobiose (Fluka) (5 g, 14.6 mmol) is dissolved in allylamine (Aldrich) (150 ml).

The reaction mixture is kept stirred magnetically at ambient temperature for 72 h. Thin layer chromatography (“TLC”, ethyl acetate/petroleum ether 1/1) is carried out on an aliquot acetylated according to a conventional method (pyridine/acetic anhydride 1/1). After evaporating to dryness, the product obtained is a white powder.

The crude reaction product is selectively N-acetylated in a methanol/acetic anhydride solution (100 ml, 5/1, v/v). The conversion is monitored by thin layer chromatography (acetonitrile/water 7/3). The solution is left stirring for 4 h and then evaporated to dryness after addition of methanol (3 times). TLC shows the formation of a second compound which is probably O-acetylated. In order to remove it, the crude product is taken up in methanol (100 ml) and a 1M MeONa solution is added dropwise until a pH of 10 is obtained. This pH is determined by deposition of a drop of reaction mixture on a strip of moistened pH paper. Monitoring by TLC shows the disappearance of the O-acetylated compound. The solution is subsequently neutralized on Amberlite IR 120H⁺ resin, filtered, evaporated to dryness and lyophilized. Product 2 is obtained with a quantitative yield (6.18 g).

¹H NMR (300 MHz, D₂O, 353K)

δ=5.86-5.98 (dddd-oct, 1H, CH═CH₂), 5.32 (d, 1H, J_{1.2}=8.04 Hz, H₁^{β}), 5.32-5.15 (m, 2H, —CH═CH₂), 4.54 (d, H₁^{II}), 4.05-3.91 (m, 2H, —CH₂—CH═CH₂), 3.83-3.77 (m, 2H, H-6^{II}), 3.75-3.71 (m, H-6), 3.75-3.67 (m, 4H, H-2, H-3, H-4, H-5), 3.56-3.31 (m, 4H, H-3^{II}, H-5^{II}, H-4^{II}, H-2^{II}), 2.23 (s, 3H, —CH₃ (Ac)).

¹³C NMR (75 MHz, D₂O, 300K)

δ=178.41 (—C═O), 135.4 (CH═CH₂), 117.76 (CH═CH₂), 103.44 (C-1^{II}), 83.42 (C-1), 79.45 (C-2), 77.88 (C-3), 77.07 (C-3^{II}), 76.75 (C-5), 76.34 (C-5^{II}), 74.30 (C-2^{II}), 70.71 and 68.91 (C-4 and C-4^{II}), 61.85 (C-6^{II}), 61.41 (C-6), 42.49 (CH₂—CH═CH₂), 24.33 (—CH₃ (Ac)).

MS (FAB⁺): m/z=424 [M+H]⁺

m/z=446 [M+Na]⁺.

### Stage 2: Synthesis of N-acetyl-N—[(N-2-thioaminoethyl)-propyl]-β-D-glucopyranosyl-(1→4)-β-D-glucopyranosylamine (product 3) by photochemical reaction

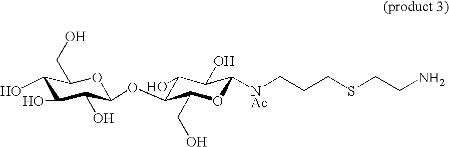

Product 2 (5 g, 11.8 mmol), taken up in a minimum amount of water (25 ml) in a photochemical cell, is treated with cysteamine (2-aminoethanethiol hydrochloride, 98%, Acros Organics) (9.36 g, 82.6 mmol, 7 eq.).

The entire contents are irradiated (254 nm) under argon and kept stirred magnetically at ambient temperature for 24 h. Thin layer chromatography reveals the presence of product 3. The latter is purified on a column of ion-exchange resin (Dowex X 50 WX4) of H⁺ ionic form and is successively eluted with H₂O and 0.1M NH₄OH. Product 3 is subsequently lyophilized and is obtained with a yield of 65% (3.8 g, 7.68 mmol).

¹H NMR (300 MHz, D₂O, 353K)

δ=5.02 (d, 1H, J_{1.2}=8.04 Hz, H₁^{β}), 4.56 (d, 1H, H₁^{II}), 4.01-3.36 (m, 16H), 2.75-2.63 (m, 4H, S—CH₂ and CH₂—S) 2.27 (s, 3H, CH₃ (Ac)), 1.94 (m, 2H, —CH₂)

¹³C NMR (75 MHz, D₂O, 303K)

δ=176.6 and 175.74 (—C═O), 102.86 (C-1^{II}), 87.22 (C-1), 78.47 and 77.39 (C-2 and C-3), 77.17 (C-3^{II}) 76.39 (C-5^{II}), 75.75 (C-5), 73.52 (C-2^{II}), 70.31 (C-4), 69.84 (C-4^{II}), 60.99 (C-6^{II}), 60.46 (C-6), 40.65 (—CH₂), 29.72 (—CH₂), 29.50-28.62-28.23 (3*—CH₂), 21.90-21.73 (—CH₃ (Ac)).

MS (FAB⁺): m/z=501 [M+H]⁺

### Stage 3: Synthesis of N-acetyl-N—[(N-2-thioethyl)-2-propenamide]propyl]-β-D-glucopyranosyl-(1→4)-β-D-glucopyranosylamine (product 4)

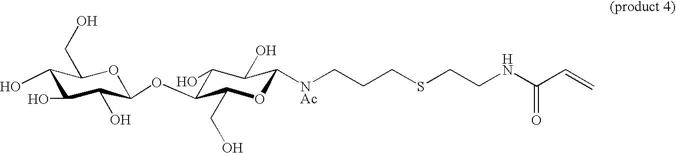

Product 3 (5 g, 10 mmol) is dissolved in a water/methanol mixture (75 ml; 1/1, v/v) in the presence of sodium carbonate (7.7 g). The medium is kept stirred magnetically at 0° C. while a solution of acryloyl chloride (4.6 ml, 56.9 mmol., Fluka) and THF (35 ml) is added gradually over 5 min. Thin layer chromatography (CH₃CN/H₂O: 6/4) shows complete conversion of product 3 to a compound having an Rf=0.6. The mixture is taken up in 300 ml of water, then reconcentrated and taken up once more in 200 ml of water in the presence of a radical inhibitor (2,6-di(tert-butyl)-4-methylphenol) (7.7 ml of a THF solution comprising 0.5% of inhibitor). Product 4 is concentrated, then purified on a column of C18 silica gel and lyophilized (5.5 g, 100%).

¹H NMR (300 MHz, D₂O, 353K)

δ=6.249 (m, 2H, CH═CH₂), 5.799 (dd, 1H, CH═CH₂), 4.95 (d, 1H, J_{1.2}=7.68 Hz, H₁^{β}), 4.55 (d, 1H, H₁^{II}), 4.17-3.31 (m, 16H), 2.79 (m, 2H, NCH₂CH₂CH₂S), 2.65 (m, 2H, NCH₂CH₂CH₂S), 2.24 (s, 3H, CH₃ (Ac)), 1.94 (m, 2H, NCH₂CH₂CH₂S).

¹³C NMR (75 MHz, D₂O, 303K)

δ=175.89 and 168.95 (—C═O) 130.35 (CH═CH₂) and 127.80 (CH═CH₂), 102.90 (C-1^{II}), 87.27 (C-1), 78.57 and 77.46 (C-2 and C-3), 77.24 (C-3^{II}), 76.41 (C-5^{II}), 75.87 (C-5), 73.57 (C-2^{II}), 70.33 (C-4), 69.87 (C-4^{II}), 60.99 (C-6^{II}), 60.58 (C-6), 39.16 (—CH₂), 30.92, 30.70, 28.99, 28.37 (4*-CH₂), 21.76 (—CH₃ (Ac)).

MS (FAB+): m/z=577 [M+Na]⁺.

High resolution mass spectrum (ESI+): C₂₂H₃₈N₂O₁₂S

Value calculated: m/z=577.20432 [M+Na]⁺

Value measured: m/z=577.2043 [M+Na]⁺

### Example 2

### Synthesis of a Copolymer Comprising Units Deriving from MAPTAC and Units Deriving from Product 4

Molar ratio: 95% MAPTAC, 5% product 4
Method: Introduction of MAPTAC and product 4 into a closed stirred reactor

### Initiator: V50

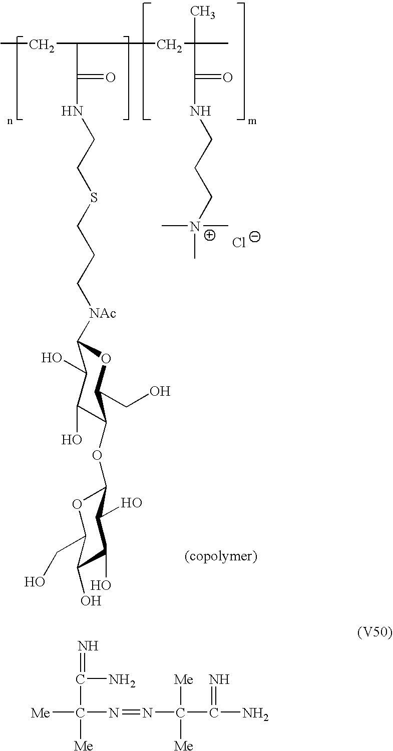

Product 4 (0.376 g) and MAPTAC (6 g, Aldrich) are diluted in a minimum amount of water (3 g) at 80° C. under a stream of nitrogen. The V50 is injected every hour for three hours. The polymerization follows the following protocol:
t⁰: injection of initiator at 0.4 mol %, with respect to the sum of the monomers (13.8 mg in 250 μl of H₂O)
t¹ injection of initiator at 0.4 mol %, with respect to the sum of the monomers (13.8 mg in 250 μl of H₂O)
t²: initiator at 0.2 mol %, with respect to the sum of the monomers (6.9 mg in 250 μl of H₂O)
t³: initiator at 0.2 mol %, with respect to the sum of the monomers (6.9 mg in 250 μl of H₂O)
   heating at 85° C. for one hour
t⁴: the solution is allowed to return to ambient temperature
   Overall conversion: 99%

After ultrafiltration over a 10 KDa membrane, the polymer is obtained with a yield by weight of 83%.

The number-average molar mass (Mn) and the weight-average molar mass (Mw) are measured by GPC coupled to MALS and conductimetry under the following conditions:
Columns: precolumn+3 Aquagel Mixed columns from Polymer Laboratories (30 cm, 8 μm)
Temperature: ambient temperature (22° C.)
Detectors:
   Refractometer: RI Waters 410, sensitivity 8, T° 40° C. RP03484
   DDL: MALLS light scattering, Wyatt, He laser 633 nm RP03810
   Conductimeter: Waters R432 (10 μS/V)
Eluent: Millipore 18 MΩ water, NBu₄Br 0.065M, NaN₃ 1/10 000, HCOOH 1 ml/5 l carrier, polydiallyldimethylammonium chloride (PDAMAC) of high weight 10 ppm dry
Flow rate: 1 ml/min
Concentration: 40 mg/20 ml
Volume injected: 100 μl, filtration 0.45 μm

Mw: 1 244 000 g/mol

Mn: 360 000 g/mol

### Example 3

### Synthesis of Oligomers Derived from Xyloglucans

Stage 1: Hydrolysis of xyloglucans. Production of the XXXG, XXLG (or XLXG) and XLLG oligomers (products 5, 6 and 7) by cellulase 3042A

The operation is carried out on a mixture comprising the DPs 7, 8 and 9, respectively the XXXG, the XXLG (or XLXG) and the XLLG, in a molar ratio of 15%, 35% and 50%.

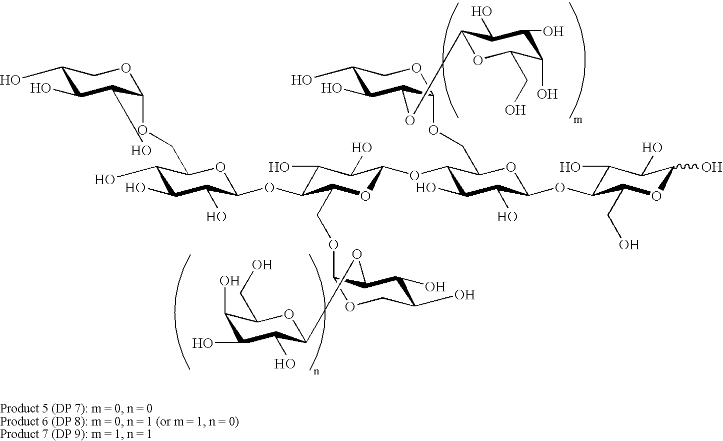

13 g of tamarind seed xyloglucan (3A, Dainippon Pharmaceutical) are suspended in distilled water (1 l) at 37° C. with stirring. After dissolution, cellulase 3042A (2.7 ml) is then added to the medium. The mixture is stirred for four hours. Thin layer chromatography (CH₃CN/H₂O: 7/3) shows the formation of products 5, 6 and 7.

The solution is subsequently brought to reflux, in order to denature the enzyme, filtered and lyophilized. Two successive ultrafiltrations are carried out with 500 Da and 10 000 Da membranes. After these ultrafiltrations, the mixture of products 5, 6 and 7 is obtained with a yield by weight of 80%.

MS (MALDI-TOF): (5) m/z=1085 [M+Na]⁺

(6) m/z=1247 [M+Na]⁺

(7) m/z=1409 [M+Na]⁺

### Stage 2: Synthesis of N-acetyl-N-ally-glycosylamines (products 8, 9 and 10)

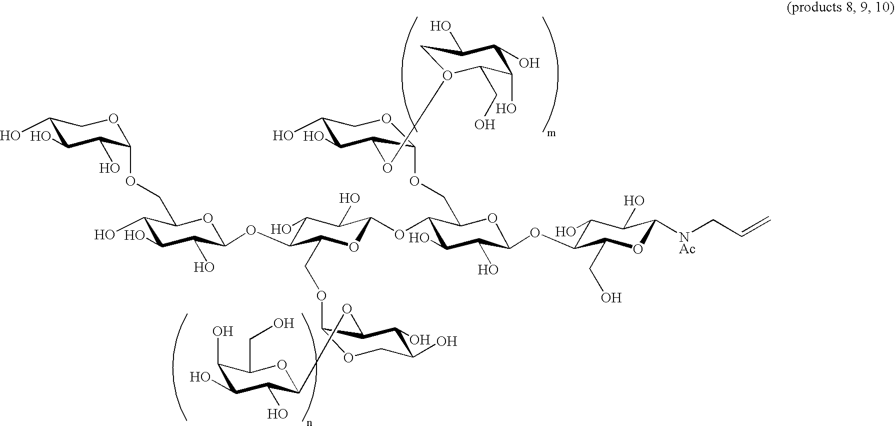

The mixture of 5, 6 and 7 (5 g) is dissolved in allylamine (100 ml, Aldrich). The reaction mixture is kept stirred magnetically at ambient temperature for 4 days. After evaporating to dryness (coevaporation with toluene), the mixture obtained is a white solid which is selectively N-acetylated overnight in 1 l of a MeOH/Ac₂O solution (20/1, v/v). The conversion is monitored by thin layer chromatography (CH₃CN/H₂O: 6/4). Products 8, 9 and 10 are subsequently concentrated and lyophilized (4.9 g, 94%)

MS (MALDI-TOF): (8) m/z=1166 [M+Na]⁺

(9) m/z=1328 [M+Na]⁺

(10) m/z=1490 [M+Na]⁺

¹H NMR (300 MHz, D₂O, 353K)

δ=5.96 (dddd, 1H, CH═CH₂), 5.29 (m, 1H, CH═CH₂), 5.18 and 4.98 (d, 1H, H_{1xyl}), 4.58 (dd, 1H, H_{1gluc and gal}), 4.10-3.41 (m, H), 2.27 (s, 3H, CH₃ (Ac)).

### Stage 3: Synthesis of N-acetyl-N—[(N-2-thioaminoethyl)-propyl]-β-D-glucosylamine (products 11, 12 and 13)

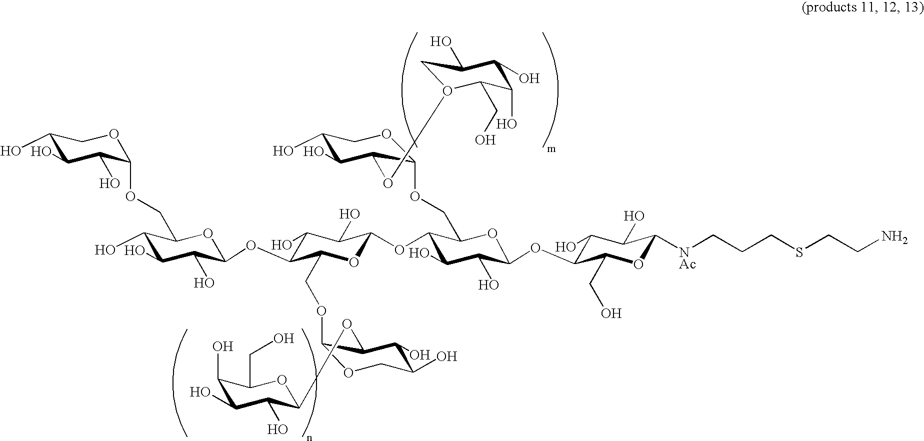

The mixture of 8, 9 and 10 (20 g, 15 mmol), taken up just to solubility in the minimum amount of distilled water (250 ml), is treated with cysteamine (2-aminoethanethiol hydrochloride, 98%, Acros Organics) (8.69 g, 5 eq.).

The solution is irradiated at 254 nm in a quartz photochemical cell kept under argon. The reaction mixture is left under magnetic stirring for 48 h. Thin layer chromatography (CH₃CN/H₂O: 1/1) shows virtually complete conversion of a mixture. Products 11, 12 and 13 are washed with methanol to remove the excess cysteamine, filtered through a Büchner funnel and purified on an ion-exchange resin (Dowex 50WX4) of H⁺ ionic form activated by 0.5M HCl and eluted successively with H₂O and 0.1M NH₄OH. 11, 12 and 13 are lyophilized (17 g, 81%)

MS (MALDI-TOF): (11) m/z=1221 [M+H]⁺

(12) m/z=1383 [M+H]⁺

(13) m/z=1545 [M+H]⁺

¹H NMR (300 MHz, D₂O, 353K)

δ=5.19 and 4.98 (d, 1H, H_{1xyl}), 4.61 (dd, H, H_{1gluc and gal}) δ 4.06-3.41 (m, H), 2.80 (m, 2H, NCH₂CH₂CH₂S), 2.68 (m, 2H, NCH₂CH₂CH₂S), 2.28 (s, 3H, CH₃ (Ac)), 1.96 (m, 2H, NCH₂CH₂CH₂S).

### Stage 4: Synthesis of 3-(2-N—[(N-2-thioethyl)-2-propenamide]propyl]-β-D-glucosylamine macromonomers (products 14, 15 and 16)

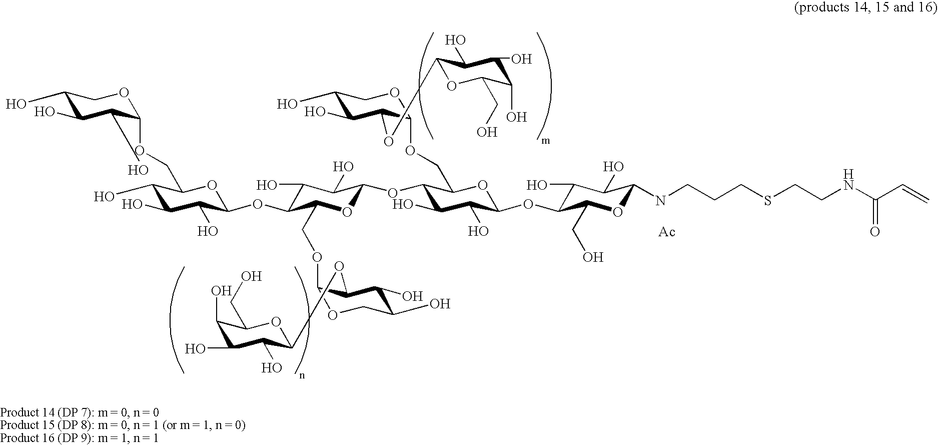

Products 11, 12 and 13 (7.8 g, 5.43 mmol) are dissolved in a water/methanol mixture (40 ml; 1/1) in the presence of sodium carbonate (4 g). The medium is kept stirred magnetically at 0° C. while a solution of acryloyl chloride (2.4 ml, 29.6×10⁻³ mol, Fluka) and THF (20 ml) is gradually added over 5 min. The reaction is monitored by thin layer chromatography (CH₃CN/H₂O: 6/4). The mixture is taken up in 120 ml of water, then reconcentrated and taken up once more in 80 ml of water in the presence of a radical inhibitor (2,6-di(tert-butyl)-4-methylphenol) (100 μl of a 0.5% THF solution). The mixture of 14, 15 and 16 is concentrated, then purified on a column of C18 silica gel and lyophilized (8 g, 100%).

MS (MALDI-TOF): (14) m/z=1297 [M+Na]+

(15) m/z=1459 [M+Na]⁺

(16) m/z=1621 [M+Na]⁺

¹H NMR (300 MHz, D₂O, 353K)

δ=6.32-6.20 (m, 2H, CH═CH₂), 5.80 (dd, 1H, CH═CH₂), 5.18 and 4.98 (d, 2H, H_{1xyl}), 4.61 (d, H, H_{1glc and gal}) δ 4.09-3.40 (m, H), 2.84 (m, 2H, NCH₂CH₂CH₂S), 2.68 (m, 2H, NCH₂CH₂CH₂S), 2.26 (s, 3H, CH₃ (Ac)), 1.95 (m, 2H, NCH₂CH₂CH₂S).

### Example 4

### Synthesis of a Copolymer Comprising Units Derived from MAPTAC and Units Deriving from Products 14, 15 and 16

Molar ratio: 95% MAPTAC, 5% mixture of 14, 15 and 16
Method: introduction of MAPTAC and the mixture into a closed stirred reactor

### Initiator: V50

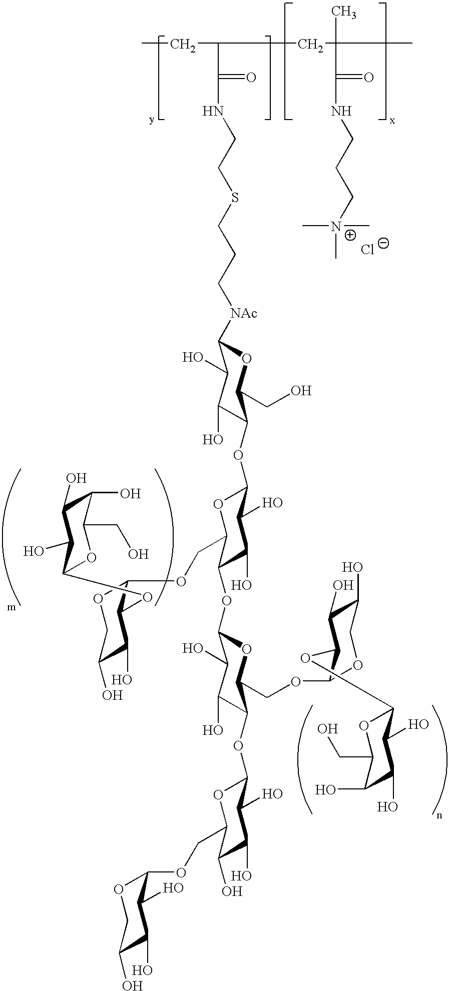

The products 14, 15 and 16 (0.976 g) and the MAPTAC (6 g, Aldrich) are diluted in the minimum amount of water (7 g) at 80° C. under a stream of nitrogen. The V50 is injected every hour for three hours. The polymerization follows the protocol:
t⁰: injection of initiator at 0.4 mol %, with respect to the sum of the monomers (13.8 mg in 250 μl of H₂O)
t¹: injection of initiator at 0.4 mol %, with respect to the sum of the monomers (13.8 mg in 250 μl of H₂O)
t²: initiator at 0.2 mol %, with respect to the sum of the monomers (6.9 mg in 250 μl of H₂O)
t³: initiator at 0.2 mol %, with respect to the sum of the monomers (6.9 mg in 250 μl of H₂O) heating at 85° C. for one hour
t⁴: the solution is allowed to return to ambient temperature.

250 μl samples are taken every hour for kinetic studies and hydroquinone (reaction inhibitor) is added to each sample.

### Conversion: 96% MAPTAC

95% products 14, 15 and 16

After ultrafiltration over a 10 KDa membrane, the polymer is obtained with a yield by weight of 83%.

Mw: 3 047 000 g/mol

Mn: 795 000 g/mol

### Example 5

### Synthesis of an N-acetyl-N—[(N-2-thioethyl)-2-propenamide]propyl]-β-D-glucopyranosyl-(1→4)-β-D-glucopyranosylamine monomer (product 4a)

### Stage 1: Synthesis of N-acetyl-N-allyl-β-D-glucopyranosyl-(1→4)-β-D-glucopyranosylamine (product 2a)

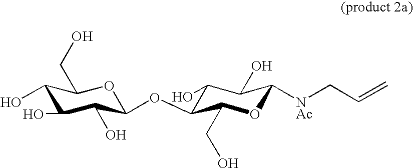

Cellobiose (Fluka) (5 g, 14.6 mmol) is dissolved in allylamine (Aldrich) (150 ml).

The reaction mixture is kept stirred magnetically at ambient temperature for 72 h. Thin layer chromatography (“TLC”, ethyl acetate/petroleum ether 1/1) is carried out on an aliquot acetylated according to a conventional method (pyridine/acetic anhydride 1/1). After evaporating to dryness, the product obtained is a white powder.

The crude reaction product is selectively N-acetylated in a methanol/acetic anhydride solution (100 ml, 5/1, v/v). The conversion is monitored by thin layer chromatography (acetonitrile/water 7/3). The solution is left stirring for 4 h and then evaporated to dryness after addition of methanol (3 times). TLC shows the formation of a second compound which is probably O-acetylated. In order to remove it, the crude product is taken up in methanol (100 ml) and a 1M MeONa solution is added dropwise until a pH of 10 is obtained. This pH is determined by deposition of a drop of reaction mixture on a strip of moistened pH paper. Monitoring by TLC shows the disappearance of the O-acetylated compound. The solution is subsequently neutralized on Amberlite IR 120H⁺ resin, filtered, evaporated to dryness and lyophilized. Product 2a is obtained with a quantitative yield (6.18 g).

¹H NMR (300 MHz, D₂O, 353K)

δ=5.86-5.98 (dddd-oct, 1H, CH═CH₂), 5.32 (d, 1H, J_{1.2}=8.04 Hz, H₁^{β}), 5.32-5.15 (m, 2H, —CH═CH₂), 4.54 (d, H₁^{II}), 4.05-3.91 (m, 2H, —CH₂—CH═CH₂), 3.83-3.77 (m, 2H, H-6^{II}), 3.75-3.71 (m, H-6), 3.75-3.67 (m, 4H, H-2, H-3, H-4, H-5), 3.56-3.31 (m, 4H, H-3^{II}, H-5^{II}, H-4^{II}, H-2^{II}), 2.23 (s, 3H, —CH₃ (Ac)).

¹³C NMR (75 MHz, D₂O, 300K)

δ=178.41 (—C═O), 135.4 (CH═CH₂), 117.76 (CH═CH₂), 103.44 (C-1^{II}), 83.42 (C-1), 79.45 (C-2), 77.88 (C-3), 77.07 (C-3^{II}), 76.75 (C-5), 76.34 (C-5^{II}), 74.30 (C-2^{II}), 70.71 and 68.91 (C-4 and C-4^{II}), 61.85 (C-6^{II}), 61.41 (C-6), 42.49 (CH₂—CH═CH₂), 24.33 (—CH₃ (Ac)).

MS (FAB⁺): m/z=424 [M+H]⁺

m/z=446 [M+Na]⁺.

### Stage 2: Synthesis of N-acetyl-N—[(N-2-thioaminoethyl)-propyl]-β-D-glucopyranosyl-(1→4)-β-D-glucopyransoylamine (product 3a) using water-soluble initiators

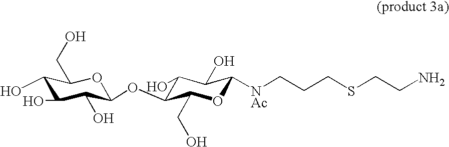

Cysteamine (2-aminoethanethiol hydrochloride, 98%, Acros Organics) (25 g, 0.22 mol, 3.7 eq.) and V-50 (α,α′-azodiisobutyramidine dihydrochloride, 98%, Fluka) (16 g, 59 mmol, 1 eq.) are added to a solution of product 2a (25 g, 59 mmol) in water (400 ml). The reaction mixture is stirred at 60° C. for 2 h under an argon atmosphere. The reaction is monitored by thin layer chromatography (AcOEt/AcOH/H₂O 3/3/2 v/v/v). The solution is subsequently purified on a column of ion-exchange resin (Dowex X 50 WX4) of H⁺ ionic form and eluted successively with H₂O and 0.05M and then 0.1M NH₄OH. The product 3a is subsequently lyophilized and is obtained with a yield of 95% (28 g, 56 mmol).

### Stage 3: Synthesis of N-acetyl-N—[(N-2-thioethyl)-2-propenamide]propyl]-β-D-glucopyranosyl-(1→4)-β-D-glucopyranosylamine (product 4a)

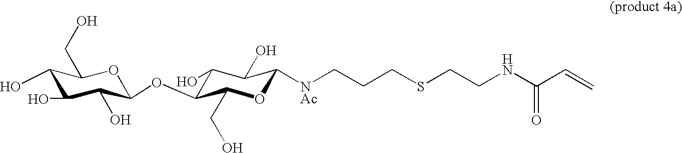

Product 3a (5 g, 10 mmol) is dissolved in a water/methanol mixture (75 ml; 1/1, v/v) in the presence of sodium carbonate (7.7 g). The medium is kept stirred magnetically at 0° C. while a solution of acryloyl chloride (4.6 ml, 56.9 mmol, Fluka) and THF (35 ml) is added gradually over 5 min. Thin layer chromatography (CH₃CN/H₂O: 6/4) shows complete conversion of product 3a to a compound having an Rf=0.6. The mixture is taken up in 300 ml of water, then reconcentrated and taken up once more in 200 ml of water in the presence of a radical inhibitor (2,6-di(tert-butyl)-4-methylphenol) (7.7 ml of a THF solution comprising 0.5% of inhibitor). Product 4a is concentrated, then purified on a column of C18 silica gel and lyophilized (5.5 g, 100%).

¹H NMR (300 MHz, D₂O, 353K)

δ=6.249 (m, 2H, CH═CH₂), 5.799 (dd, 1H, CH═CH₂), 4.95 (d, 1H, J_{1.2}=7.68 Hz, H₁^{β}), 4.55 (d, 1H, H₁^{II}), 4.17-3.31 (m, 16H), 2.79 (m, 2H, NCH₂CH₂CH₂S), 2.65 (m, 2H, NCH₂CH₂CH₂S), 2.24 (s, 3H, CH₃ (Ac)), 1.94 (m, 2H, NCH₂CH₂CH₂S).

¹³C NMR (75 MHz, D₂O, 303K)

δ=175.89 and 168.95 (—C═O) 130.35 (CH═CH₂) and 127.80 (CH═CH₂), 102.90 (C-1^{II}), 87.27 (C-1), 78.57 and 77.46 (C-2 and C-3), 77.24 (C-3^{II}), 76.41 (C-5^{II}), 75.87 (C-5), 73.57 (C-2^{II}), 70.33 (C-4), 69.87 (C-4^{II}), 60.99 (C-6^{II}), 60.58 (C-6), 39.16 (—CH₂), 30.92, 30.70, 28.99, 28.37 (4*-CH₂), 21.76 (—CH₃ (Ac)).

MS (FAB+): m/z=577 [M+Na]⁺.

High resolution mass spectrum (ESI+): C₂₂H₃₈N₂O₁₂S

Value calculated: m/z=577.20432 [M+Na]⁺

Value measured: m/z=577.2043 [M+Na]⁺

1.-17. (canceled)

18. A polymer comprising:
a cationic or potentially cationic unit A_{c} optionally derived from a cationic or potentially cationic mono-α-ethylenically unsaturated monomer; and
a unit derived from a monomer of formula (I): 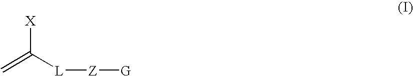
in which:
X is a hydrogen atom or a methyl group;
L is a divalent linking group;
Z is an oxygen or sulfur atom or a group comprising a nitrogen atom; and
G is a glycoside.

19. The polymer as defined by claim 18, wherein:
Z is an oxygen atom or an —NH— or —N[COCH₃]— group, and
G is bonded to -Z- via an anomeric carbon of the glycoside.

20. The polymer as defined by claim 18, wherein the glycoside G is a polyglycoside.

21. The polymer as defined by claim 18, wherein G has the formula G^{a}-G^{b} in which G^{a} is a glycoside and G^{b} is a linking glycoside bonded to the -Z- group via an anomeric carbon.

22. The polymer as defined by claim 18, wherein -G is a glycoside selected from the group consisting of:
glucose, fructose, sorbose, mannose, galactose, talose, allose, gulose, idose, glucosamine, mannoamine, galactosamine, glucuronic acid, rhamnose, arabinose, galacturonic acid, fucose, xylose, lyxose, ribose or sucrose isomers,
maltose, gentiobiose, lactose, cellobiose, isomaltose, melibiose, laminaribiose, chitobiose, xylobiose, mannobiose or sophorose,
maltotriose, isomaltotriose, maltotetraose, maltopentaose or maltoheptaose,
mannotriose or mannotriose,
chitotriose, chitotetraose or chitopentaose,
cellotetraoses or cellodextrins,
maltose or maltodextrins,
cellulose,
pectins,
chitin, chitosan,
glucoaminoglucans,
xyloglucans, and
galactomannans.

23. The polymer as defined by claim 18, wherein the units deriving from the monomer of formula (I) derive from a monomer of following formula (I′): 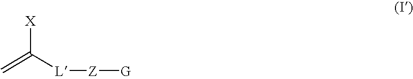
in which:
X is a hydrogen atom or a methyl group;
Z is an oxygen atom or a group comprising a nitrogen atom; and
G is a glycoside, wherein:
the -L′-Z-G group exhibits the following formula (II′):
—COY-L¹-S-L²-Z-G (II′)
in which:
Y is a divalent linking group or a linking atom,
L¹ is a divalent linking group,
L² is a divalent linking group, and
G is bonded to Z via an anomeric carbon of the glycoside.

24. The polymer as defined by claim 23, wherein L¹ and L² are divalent hydrocarbon groups.

25. The polymer as defined by claim 23, wherein L¹ and L² are divalent C₁-C₆ alkyl groups.

26. The polymer as claimed in claim 23, wherein:
Y is —O— or —NH—, and
L¹ and L², which are identical or different, are C₁-C₄ alkyl groups.

27. The polymer as defined by claim 18, wherein the units derived from the monomer of formula (I) are derived from a monomer of following formula (III′):

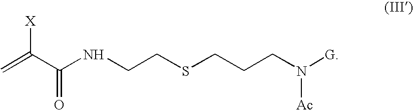

28. The polymer as defined by claim 18, wherein the cationic or potentially cationic units are derived from cationic or potentially cationic monomers selected from the group consisting of:
ω-(N,N-dialkylamino)alkylamides of α,β-monoethylenically unsaturated carboxylic acids;
α,β-monoethylenically unsaturated amino esters;
vinylpyridines, vinylpyrrolidone or vinylcaprolactam;
vinylamine;
vinylimidazolines;
precursor monomers of amine functional groups;
ammonioacryloyl or -acryloyloxy monomers;
1-ethyl-2-vinylpyridinium or 1-ethyl-4-vinyl-pyridinium bromide, chloride or methyl sulfate;
N,N-dialkyldiallylamine monomers; and
polyquatenary monomers.

29. The polymer as defined by claim 28, wherein the ω-(N,N-dialkylamino)alkylamides of α,β-monoethylenically unsaturated carboxylic acid is a 2-(N,N-dimethylamino)ethylacrylamide or -methacrylamide, 3-(N,N-dimethylamino)propylacrylamide or -methacrylamide, 4-(N,N-dimethylamino)butylacrylamide or -methacrylamide or methacrylamidoethylethyleneurea.

30. The polymer as defined by claim 28, wherein α,β-monoethylenically unsaturated amino ester is a 2-(dimethylamino)ethyl acrylate (ADAM), 2-(dimethylamino)ethyl methacrylate (DMAM), 3-(dimethylamino)propyl methacrylate, 2-(tertbutylamino)ethyl methacrylate, 2-(dipentylamino)ethyl methacrylate, 2-(diethylamino)ethyl methacrylate or methacryloyloxyethylethyleneurea.

31. The polymer as defined by claim 28, wherein the precursor monomer of amine functional groups is a N-vinylformamide or N-vinylacetamide, which produce primary amine functional groups by simple acidic or basic hydrolysis.

32. The polymer as defined by claim 28, wherein the ammonioacryloyl or -acryloyloxy monomer is a trimethylammoniopropyl methacrylate chloride, trimethylammonioethylacrylamide or -methacrylamide chloride or bromide, trimethylammoniobutylacrylamide or -methacrylamide methyl sulfate, trimethylammoniopropylmethacrylamide methyl sulfate (MES), (3-methacrylamidopropyl)trimethylammonium chloride (MAPTAC), (3-acrylamidopropyl)trimethylammonium chloride (APTAC), (methacryloyloxyethyl) trimethylammonium chloride or methyl sulfate, (acryloyloxyethyl)trimethylammonium chloride or (acryloyloxyethyl)benzyldimethylammonium ethyl chloride (ADAMQUAT BZ).

33. The polymer as defined by claim 28, wherein the N,N-dialkyldiallylamine monomer is N,N-dimethyldiallylammonium chloride (DADMAC).

34. The polymer as defined by claim 28, wherein the polyquatenary monomer is a chloride of dimethylaminopropylmethacrylamide, N-(3-chloro-2-hydroxypropyl)trimethylammonium (DIQUAT).

35. The polymer as defined by claim 18, further comprising, in addition to the cationic or potentially cationic units:
hydrophilic or hydrophobic neutral units A_{N}, and/or
anionic or potentially anionic units A_{A}.

36. The polymer as defined by claim 18, wherein the polymer is a random copolymer, a block copolymer, a concentration gradient copolymer, a star copolymer, a cooligomer or a cotelomer.

37. A method using the polymer as defined by claim 18, the method comprising incorporating the polymer into a cosmetic composition, a detergent composition, a laundry composition, a molecular recognition agent, a transmembrane passage agent, an additive for paper pulp, a coating composition for paper, or a paint.

38. The method as defined by claim 37, wherein when the polymer is incorporated into a cosmetic composition, the cosmetic composition is a shampoo, a conditioner, a shower gel or a cream for caring for the skin.

39. A monomer of formula (I′): 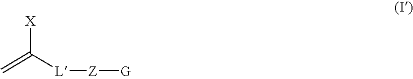
in which:
X is a hydrogen atom or a methyl group
Z is an oxygen atom or a group comprising a nitrogen atom and
G is a glycoside, wherein:
the -L′-Z-G group exhibits the following formula (II′):
—COY-L¹-S-L²-Z-G (II′)
in which:
Y is a divalent linking group or a linking atom,
L¹ is a divalent linking group,
L² is a divalent linking group, and
G is bonded to Z via an anomeric carbon of the glycoside.

40. The monomer as defined by claim 39, wherein L¹ and L² are divalent hydrocarbon groups.

41. The monomer as defined by claim 39, wherein L¹ and L² are divalent C₁-C₆ alkyl groups.

42. The monomer as defined by claim 39, wherein:
Y is —O— or —NH—, and
L¹ and L², which are identical or different, are C₁-C₄ alkyl groups.

43. The monomer as defined by claim 39, wherein the monomer has the following formula (III′):

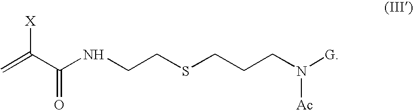

44. The monomer as defined by claim 39, wherein the monomer has the following formulae: 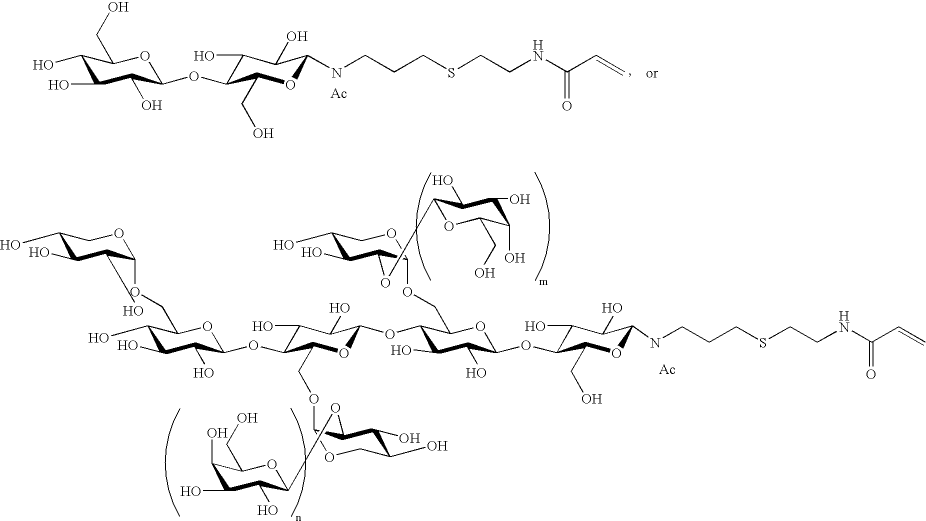
in which:
m and n, which are identical or different, are numbers from 0 to 10.

45. The monomer as defined by claim 44, wherein m and n are 0 or 1.
